(19) United States
(12) Patent Application Publication
(10) Pub. No.: US 2025/0161850 A1
(43) Pub. Date: May 22, 2025

(54) RETAINABLE AIR FILTER

(71) Applicant: Advanced FLOW Engineering Inc., Corona, CA (US)

(72) Inventors: George Chaing, Riverside, CA (US); Shahriar Nick Niakan, Anaheim Hills, CA (US)

(73) Assignee: Advanced FLOW Engineering, Inc., Corona, CA (US)

(21) Appl. No.: 18/954,230

(22) Filed: Nov. 20, 2024

Related U.S. Application Data
(60) Provisional application No. 63/600,941, filed on Nov. 20, 2023.

(51) Int. Cl. B01D 46/00; B01D 46/10; B01D 46/62

(52) U.S. Cl. CPC B01D 46/0005; B01D 46/10; B01D 46/62

(57) ABSTRACT

A detachable pre-filter assembly, an air filter with the detachable pre-filter assembly, and an air-filtration enabled device featuring the air filter with the detachable pre-filter assembly are provided. The air filter includes a perimeter frame that defines a cavity, a filter element disposed within the cavity, and a pre-filter assembly secured to the perimeter frame in a detachable configuration. The pre-filter assembly includes a pre-filter element disposed adjacent to the filter element and a retainer element disposed adjacent to the pre-filter element. The retainer element retains the pre-filter element adjacent to the filter element and engages with the perimeter frame. Thus, the retainer element retains the washable and reusable pre-filter element in place, while allowing removal, installation, and potential re-use of the pre-filter element with ease.

### PRIORITY

This application claims the benefit of and priority to U.S. Provisional Application, entitled “Retainable Air Filter” filed on Nov. 20, 2023 and having application Ser. No. No. 63/600,941, the entirety of which is incorporated herein by reference.

### FIELD

The present disclosure relates to air filters. More particularly, the present disclosure relates to a reusable pre-filter that is retained in place with a retainer frame while also providing easy removal and installation of the pre-filter.

### BACKGROUND

Traditional filtration systems often face issues of larger particle accumulation, leading to reduced efficiency. The introduction of a pre-filter (for example, a foam pre-filter) as the initial defense line prevents these larger particles from reaching and clogging a primary filter, thus extending the lifespan and effectiveness of the filtration system. However, typical pre-filters are configured to be one-time-use and are permanently fixed, for example, glued, to the primary filter, resulting in frequent replacements and increased waste.

The disposable nature of such filters contributes to environmental issues, as used filters often end up in landfills, adding to the growing problem of waste accumulation. Further, the glue used to attach the pre-filter can also pose challenges, as the glue may contain non-biodegradable materials that further contribute to pollution. Additionally, the one-time use design can be economically impractical for consumers, leading to increased costs over time. Furthermore, the fixed pre-filter limits customization and adaptability, as users cannot replace or upgrade the pre-filter independently, potentially compromising the filter's effectiveness in capturing specific pollutants.

### SUMMARY OF THE DISCLOSURE

An air filter, a pre-filter assembly for an air filter, and an air-filtration enabled device in accordance with embodiments of the disclosure are described herein.

In many embodiments, an air filter comprises a perimeter frame that defines a cavity, a filter element disposed within the cavity, and a pre-filter assembly secured to the perimeter frame in a detachable configuration. The pre-filter assembly comprises a pre-filter element and a retainer element. The pre-filter element is disposed adjacent to the filter element and the retainer element is disposed adjacent to the pre-filter element. The retainer element retains the pre-filter element adjacent to the filter element and engages with the perimeter frame.

In a number of embodiments, the pre-filter element is disposed upstream of the filter element in an airflow path through the air filter.

In a variety of embodiments, the pre-filter element is disposed below the filter element.

In more embodiments, the pre-filter element is disposed above the filter element.

In additional embodiments, the pre-filter element exhibits a porous structure.

In several embodiments, the pre-filter element exhibits a single-layer structure.

In numerous embodiments, the pre-filter element exhibits a multi-layer structure.

In various embodiments, the pre-filter element is washable and reusable.

In further embodiments, the retainer element is configured to support the pre-filter element to preserve a shape of the pre-filter element.

In yet more embodiments, the retainer element comprises a support frame and one or more bracing members. The one or more bracing members are included within a space defined by the support frame. The one or more bracing members are coupled to the support frame.

In still more embodiments, the one or more bracing members are in an X-brace configuration.

In still yet more embodiments, the pre-filter assembly is configured to support at least one detachment and reattachment iteration.

In one or more embodiments, the pre-filter assembly is configured to support at least one detachment and reattachment iteration without deformation.

In many further embodiments, the pre-filter assembly incorporates a snap-fit interface. The pre-filter assembly is secured to the perimeter frame in the detachable configuration by way of the snap-fit interface.

In many additional embodiments, the pre-filter assembly incorporates one or more interlocking features. The pre-filter assembly is secured to the perimeter frame in the detachable configuration by way of the one or more interlocking features.

In numerous additional embodiments, the pre-filter assembly is secured to the perimeter frame in the detachable configuration by way of one or more fastening elements.

In several additional embodiments, the perimeter frame comprises a perimeter wall and a flange along the perimeter wall. The perimeter wall encompasses the cavity. The flange is configured to interface with a mounting surface to mount the air filter.

In yet additional embodiments, a pre-filter assembly for an air filter is provided. The air filter comprises a perimeter frame and a filter element in the perimeter frame. The pre-filter assembly comprises a pre-filter element disposed adjacent to the filter element, and a retainer element disposed adjacent to the pre-filter element. The retainer element retains the pre-filter element adjacent to the filter element and engages with the perimeter frame. The pre-filter assembly is secured to the perimeter frame in a detachable configuration.

In still additional embodiments, an air-filtration enabled device comprises a mounting interface and air filter coupled to the mounting interface. The air filter comprises a perimeter frame that defines a cavity, a filter element disposed within the cavity, and a pre-filter assembly secured to the perimeter frame in a detachable configuration. The pre-filter assembly comprises a pre-filter element disposed adjacent to the filter element and a retainer element disposed adjacent to the pre-filter element. The retainer element retains the pre-filter element adjacent to the filter element and engages with the perimeter frame.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a diagram illustrating an exploded view of an air filter in accordance with various embodiments of the disclosure;

FIG. 2 is a conceptual illustration of an example detachable retainer element for use in an air filter in accordance with various embodiments of the disclosure;

FIG. 3 is a conceptual illustration of an example air filter with a detachable pre-filter assembly in accordance with various embodiments of the disclosure;

FIG. 4 is a side plan view of an example air filter with a detachable pre-filter assembly in accordance with various embodiments of the disclosure;

FIG. 5 is a cross-sectional view of a first cross-sectional view of an air filter with a detachable pre-filter assembly in accordance with various embodiments of the disclosure;

FIG. 6 is a second cross-sectional view of an air filter with a detachable pre-filter assembly in accordance with various embodiments of the disclosure; and

FIG. 7 is a block diagram of an air-filtration enabled device featuring an air filter with a detachable pre-filter assembly in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the problems described above, devices and methods are discussed herein that implement a retainer frame to retain a washable and reusable pre-filter in place, while allowing the removal, installation, and potential re-use of the pre-filter with ease. For example, the retainer frame and the pre-filter are detachably coupled to a primary filter. In many embodiments, the retainer frame allows the washable and reusable pre-filter to be removed and installed without any tools.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

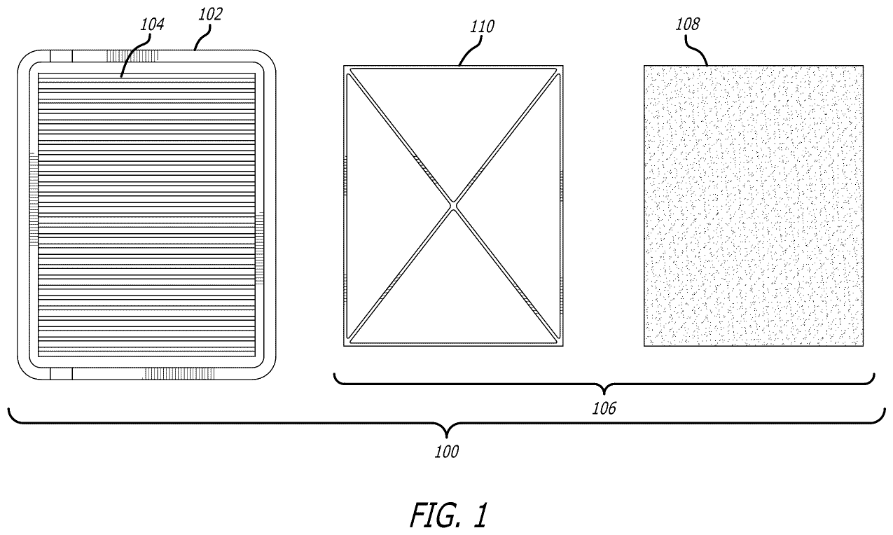

Referring to FIG. 1, a diagram illustrating an exploded view of an air filter 100 in accordance with various embodiments of the disclosure is shown. The air filter 100 may be configured to trap airborne particles such as dust, pollen, pollutants, or the like to provide cleaner air. Examples of various devices where the air filter 100 can be deployed may include, but are not limited to, vacuum cleaners, heating, ventilation, and air conditioning (HVAC) systems, air purifiers, or any other devices that help maintain air quality. In further embodiments, the air filter 100 can be deployed in automotive cabins, industrial settings, medical environments, or the like to enhance air purity and safeguard health. The air filter 100 may prevent the circulation of harmful contaminants, promoting cleaner and safer air for various applications.

In many embodiments, the air filter 100 may include a perimeter frame 102, a filter element 104, and a pre-filter assembly 106. The perimeter frame 102 may be a sturdy frame configured to substantially envelope the filter element 104, providing structural support and a housing for the air filter 100. In a number of embodiments, the perimeter frame 102 may define a cavity, and the filter element 104 may be disposed within the cavity. In various examples, the filter element 104 may be configured to trap finer particles, including allergens, bacteria, and smaller pollutants, ensuring clean and breathable air. Examples of various materials used to form the filter element 104 may include, but are not limited to, High-Efficiency Particulate Air (HEPA), activated carbon, fiberglass, polyester materials, or the like. The perimeter frame 102 may be formed from materials such as plastic, aluminum, steel, cardboard, or the like.

In a variety of embodiments, the pre-filter assembly 106 may be secured to the perimeter frame 102 in a detachable configuration. “Detachable configuration” may refer to an arrangement where the pre-filter assembly 106 can be separated from the perimeter frame 102 without damage or deformation. The detachable configuration may further indicate that the pre-filter assembly 106, once separated or removed, can be reattached to the perimeter frame 102 without damage or deformation to the perimeter frame 102 and the pre-filter assembly 106. In other words, the pre-filter assembly 106 may be configured to support at least one detachment and reattachment iteration. The detachable configuration may allow reuse or maintenance of the pre-filter assembly 106. Further, the detachable configuration may enable the disposal of worn-out parts of the pre-filter assembly 106, ensuring flexibility in operation, repair, and part replacement. In other words, the detachable configuration may facilitate modular functionality in the air filter 100, allowing ease of service, part replacement, or part upgrade.

In more embodiments, the pre-filter assembly 106 may include a pre-filter element 108 and a retainer element 110. The pre-filter element 108 may be disposed adjacent to the filter element 104, and the retainer element 110 may be disposed adjacent to the pre-filter element 108. The retainer element 110 may retain the pre-filter element 108 adjacent to the filter element 104 and engage with the perimeter frame 102. Examples of the materials used to form the pre-filter element 108 may include foam, polyester, carbon, cotton, fiberglass, or the like.

In some embodiments, the pre-filter element 108 may be disposed (e.g., placed) above the filter element 104. In certain embodiments, the pre-filter element 108 may be disposed below the filter element 104. For example, the pre-filter element 108 may be sandwiched between the filter element 104 and the retainer element 110. In these configurations, the pre-filter element 108 may be configured as the first line of defense against larger particles, debris, and contaminants present in the air. In many further embodiments, the pre-filter element 108 may exhibit a porous structure, which allows the pre-filter element 108 to capture these larger particles, preventing them from reaching and clogging the filter element 104. This two-tiered filtration approach may extend the life of the filter element 104 and enhance the overall effectiveness of the air filter 100.

In additional embodiments, the pre-filter element 108 may be adaptable to various flat panel filter shapes, whether they are 4, 5, or 6-sided, without limitation. In other words, the pre-filter element 108 may be configured in various shapes and sizes, accommodating different flat panel filter geometries. For example, depending on whether the filter element 104 is square, rectangular, circular, or features irregular contours, the pre-filter element 108 can be configured to match the specific dimensions of the filter element 104. In still additional embodiments, a second moment of area may be incorporated in the pre-filter element 108, to ensure rigidity with minimal material usage. This feature not only contributes to sustainability but also minimizes the impact on airflow restriction, making the pre-filter element 108 an efficient and effective solution for air filtration.

Unlike conventional pre-filters that are typically glued to a filter element and meant for one-time use, in various embodiments, the pre-filter element 108 is washable and reusable. Thus, providing an eco-friendly and cost-effective solution for air purification. The retainer element 110 can be detached from the perimeter frame 102, allowing the pre-filter element 108 to be removed for washing and/or cleaning. After washing or cleaning, the pre-filter element 108 can be re-disposed adjacent to the filter element 104. The retainer element 110 can then be reattached to the perimeter frame 102 to securely hold the pre-filter element 108 in place. The inclusion of the removable, disposable, and reusable pre-filter element 108 in the air filter 100 may improve the efficiency and lifespan of the air filter 100.

In more embodiments, the removable or disposable nature of the pre-filter element 108 may allow for easy maintenance and replacement. In environments where airborne particles vary in size and composition, the pre-filter element 108 can be swapped out without the need for extensive cleaning, ensuring a consistently high level of filtration efficiency over time. This adaptability is particularly advantageous in settings where air quality conditions may fluctuate. Furthermore, the pre-filter element 108 disposability may add a layer of convenience, by prioritizing a hassle-free maintenance routine. The ease of replacement reduces downtime, making the air filter 100 suitable for use in applications requiring uninterrupted air filtration, such as in HVAC systems, sensitive manufacturing environments, engine bays of motor vehicles, or the like.

In some embodiments, the pre-filter element 108 may be a single-layer structure. In some more embodiments, the pre-filter element 108 may be a multi-layer structure including a plurality of layers of the same or different porous materials. The pre-filter element 108 may allow for efficient particle capture while maintaining optimal airflow, ensuring that the subsequent filtration stages, e.g., the filter element 104, operate at their peak efficiency.

In various additional embodiments, design features of the pre-filter element 108 can vary to cater to different air quality needs and filtration system specifications. For example, material density of the pre-filter element 108 can be varied to provide a specific level of porosity tailored to a specific application. This customization, enabled by the removable aspect of the pre-filter element 108, allows fine-tuning of the filtration process based on the size and type of particles prevalent in the air. In an example scenario, the air filter 100 may also support a modular setup, offering a selection of interchangeable pre-filter elements designed to capture different types of particles. The air filter 100 can be configured by selecting a single pre-filter element or combining multiple pre-filter elements, enabling a customizable pre-filtration solution that adapts to specific environmental or operational demands.

In further additional embodiments, the pre-filter element 108 can be made to undergo an antimicrobial treatment, providing an added layer of protection against the growth of bacteria and mold in the air filter 100. This feature is advantageous in HVAC systems or medical settings where maintaining a sterile environment is required. The antimicrobial treatment may ensure that the pre-filter element 108 not only captures particles but also inhibits the growth of potentially harmful microorganisms.

In numerous embodiments, the retainer element 110 may correspond to an exoskeleton structure disposed as a detachable component or an installable component with respect to the perimeter frame 102. In numerous additional embodiments, the retainer element 110 may serve as a support structure for the pre-filter element 108, effectively retaining the pre-filter element 108 adjacent to (for example, on top of or below) the filter element 104. The retainer element 110 may further support the pre-filter element 108 to preserve a shape configuration of the pre-filter element 108. For example, in a case where the pre-filter element 108 is semi-rigid and lacks sufficient structural integrity to retain its shape under external forces or its weight, the retainer element 110 once disposed over the pre-filter element 108 may prevent the pre-filter element 108 from deforming. In other words, the retainer element 110 may be configured to securely engage with the perimeter frame 102, ensuring optimal retention of the pre-filter element 108. Thus, the retainer element 110 may enhance the longevity and effectiveness of the pre-filter element 108 by preventing the pre-filter element 108 from shifting or deforming under the influence of any external or internal factor during use.

In FIG. 1, the retainer element 110 is shown to have an X-brace or crossbar configuration. However, the scope of the retainer element 110 is not limited to the X-brace or crossbar configuration. In several embodiments, the retainer element 110 can exhibit a versatile range of shape configurations to suit different filter shapes and applications. For example, the X-brace configuration may be utilized for square or rectangular air filters, whereas circular or radial configuration can be utilized for circular or cylindrical filter geometries.

In numerous embodiments, the retainer element 110 may be a grid-like exoskeleton, resembling a mesh pattern. Such design configuration may be utilized in air filters with irregular shapes or those requiring enhanced structural integrity. The retainer element 110 having the mesh pattern may provide comprehensive coverage, securing the pre-filter element 108 across its entire surface area. In other words, in scenarios where filter geometry deviates from conventional shapes, the retainer element 110 having the mesh pattern can be utilized to allow adaptability without compromising performance.

In additional embodiments, the retainer element 110 may be a segmented exoskeleton. Segmented exoskeleton may include discreet sections that correspond to specific regions of the pre-filter element 108. This modular approach may facilitate easy installation, removal, and replacement of individual segments, catering to air filters with intricate shapes or those requiring targeted support in specific areas. The segmented exoskeleton may enhance the overall flexibility of the pre-filter assembly 106, accommodating a variety of filter shapes and sizes.

In yet additional embodiments, if the pre-filter element 108 exhibits elongated or irregular contours, the retainer element 110 may include a serpentine or zigzag exoskeleton. The serpentine or zigzag exoskeleton can follow the curves and bends of the pre-filter element 108, ensuring uniform retention of the pre-filter element 108 along its convoluted path. The serpentine exoskeleton may be adept at conforming to non-traditional filter geometries, offering stability and support in challenging configurations. The adaptability of the retainer element 110 in its various embodiments allows the pre-filter element 108 to be seamlessly integrated into a wide array of air filters. Different design configurations of the retainer element 110 may address specific challenges posed by different air filter geometries, ensuring effective support and retention of the pre-filter element 108, thereby enhancing the overall performance and longevity of the air filter 100.

In one or more embodiments, the retainer element 110 can be formed by using materials such as plastic (such as Acrylonitrile Butadiene Styrene plastic, etc.), metals or metal compositions having a Young's modulus that is greater than a threshold value for required flexibility, or the like.

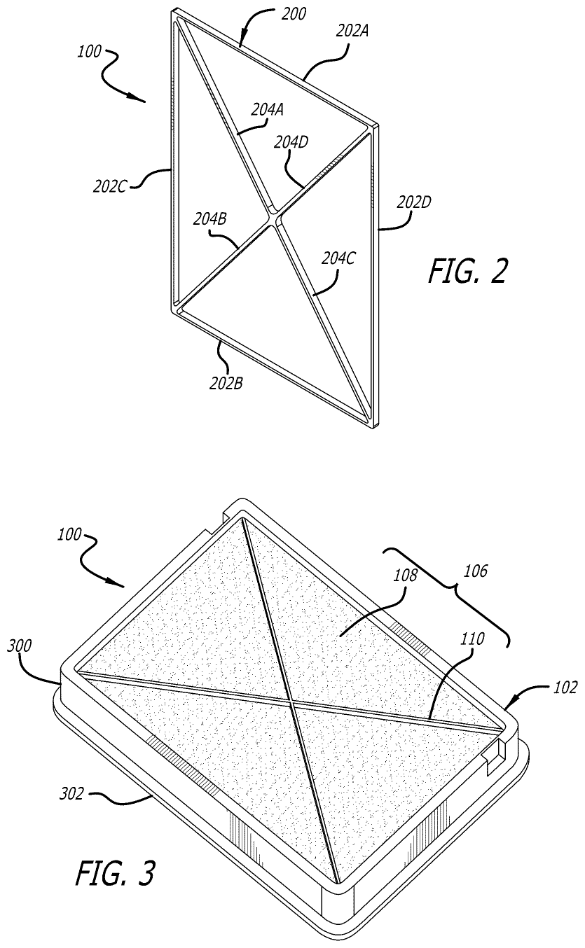

Although a specific embodiment for an air filter is described above with respect to FIG. 1, any of a variety of systems and/or processes may be utilized in accordance with embodiments of the disclosure. For example, the retainer element 110 may have a design that securely holds the pre-filter element 108 in place without impeding the flow of air through the air filter 100 and without compromising airflow efficiency of the air filter 100. The elements depicted in FIG. 1 may also be interchangeable with other elements of FIGS. 2-7 as required to realize a particularly desired embodiment.

Referring to FIG. 2, a conceptual illustration of an example detachable retainer element for use in an air filter in accordance with various embodiments of the disclosure is shown. In many embodiments, the retainer element shown in FIG. 2 may correspond to the retainer element 110 used in the air filter 100 of FIG. 1. FIG. 2 is described in conjunction with various elements from FIG. 1.

In a non-limiting example, the retainer element 110 is shown to have an X-brace or crossbar configuration in FIG. 2. In the crossbar configuration, the retainer element 110 may include a support frame 200 having a plurality of side members 202A, 202B, 202C, and 202D, representing the top, bottom, left, and right edges, respectively, of the support frame 200. The retainer element 110 may further include one or more bracing members included within a space defined by the support frame 200. The one or more bracing members may be coupled to the support frame 200. For example, in FIG. 2, the retainer element 110 is shown to include four bracing members 204A, 204B, 204C, 204D that extend towards the support frame 200 and are coupled to the support frame 200 in the X-brace configuration. As shown in FIG. 2, the bracing members 204A, 204B, 204C, 204D may be securely attached to corners of the support frame 200 at one end and to each other at a center the support frame 200. In other words, the bracing members 204A, 204B, 204C, 204D may intersect at the center of the support frame 200, creating four triangular sections within the space defined by the support frame 200. This intersection point may distribute pressure evenly across the retainer element 110, providing extra strength and preventing deformation or sagging of a pre-filter element used in an air-filter.

In a number of embodiments, the support frame 200 and the bracing members 20A, 204B, 204C, 204D may enable the retainer element 110 to preserve the shape or configuration of a removable and reusable pre-filter element (for example, the pre-filter element 108 shown in FIG. 1) used in an air filter. Further, the retainer element 110 may serve as a securing mechanism for the pre-filter element. In other words, the retainer element 110 may have a design that securely holds the pre-filter element in place without impeding the flow of air through the air filter.

Although a specific embodiment for a detachable retainer element for use in an air filter is described above with respect to FIG. 2, any of a variety of systems and/or processes may be utilized in accordance with embodiments of the disclosure. For example, the retainer element 110 can have any configuration depending on a geometry of a perimeter frame of an air-filter. The elements depicted in FIG. 2 may also be interchangeable with other elements of FIGS. 1 and 3-7 as required to realize a particularly desired embodiment.

Referring to FIG. 3, a conceptual illustration of an example air filter with a detachable pre-filter assembly in accordance with various embodiments of the disclosure is shown. In many embodiments, the air filter shown in FIG. 3 may correspond to the air filter 100 shown in FIG. 1. FIG. 3 is described in conjunction with various elements from FIGS. 1 and 2. As shown in FIG. 3, the pre-filter assembly 106, including the pre-filter element 108 and the retainer element 110, is secured to the perimeter frame 102. When the pre-filter assembly 106 is secured to the perimeter frame 102, the pre-filter element 108 gets sandwiched between the retainer element 110 and a primary filter element (for example, the filter element 104 is obscured from view in FIG. 3).

In many embodiments, the perimeter frame 102 may include a perimeter wall 300 that encompasses or envelops the cavity. The filter element and the pre-filter assembly 106, including the pre-filter element 108 and the retainer element 110, may be accommodated within the cavity. Notably, the perimeter frame 102 can be adapted to a variety of shapes, catering to different requirements of flat panel air filters. For example, in FIG. 3, the perimeter frame 102 is shown to have a rectangular shape.

In more embodiments, the perimeter frame 102 may further include a flange 302 along the perimeter wall 300. For example, the flange 302 can be a lip or abutment encircling the perimeter wall 300 and extending away from the perimeter wall 300. The flange 302 may reinforce the structural integrity of the perimeter frame 102 and may seamlessly interface with a mounting surface, for example, to mount the air filter 100. For example, the flange 302 may include secure attachment points designed to connect with the mounting surface, for example, an air intake system. The secure attachment may ensure a snug fit and prevent any potential displacement of various elements during the vibrations and movements typical in automotive environments.

Further, in the context of engine bay installations, the flange 302 surrounding the perimeter wall 300 may serve as an extra layer of defense against harsh conditions encountered in motor vehicles. Thus, reinforcing the durability and reliability of the pre-filter assembly 106. In HVAC scenarios, the flange 302 may facilitate the integration of the air filter 100 into an HVAC unit, for example, by connecting to existing ductwork or filter housing mechanisms in the HVAC unit. Thus, inclusion of the flange 302 on the perimeter frame 102 may increase the ease of installation of the air filter 100.

Although a specific embodiment for an air filter with a detachable pre-filter assembly is described above with respect to FIG. 3, any of a variety of systems and/or processes may be utilized in accordance with embodiments of the disclosure. For example, the flange 302 can be continuous or segmented. The elements depicted in FIG. 3 may also be interchangeable with other elements of FIGS. 1, 2 and 4-7 as required to realize a particularly desired embodiment.

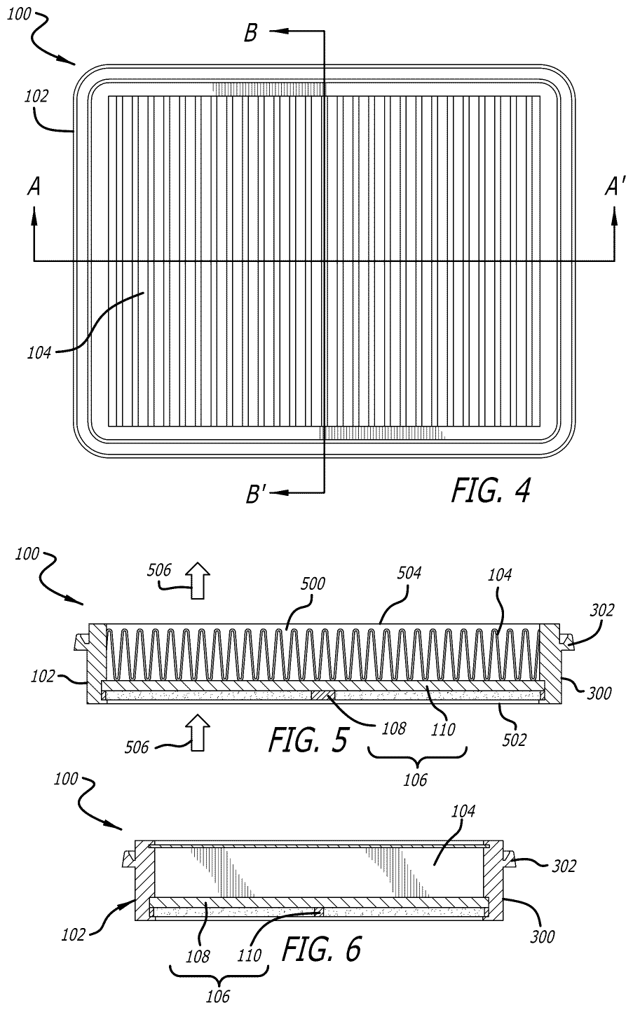

Referring to FIG. 4, a side plan view of an example air filter with a detachable pre-filter assembly in accordance with various embodiments of the disclosure is shown. In many embodiments, the air filter shown in FIG. 4 may correspond to the air filter 100 shown in FIG. 1. FIG. 4 is described in conjunction with various elements from FIGS. 1, 2, and 3. In a number of embodiments, the air filter 100 may include the perimeter frame 102 encompassing the filter element 104. In a variety of embodiments, the filter element 104 may be disposed in the cavity of the perimeter frame 102, for example, in a sinusoidal configuration. A first cross-sectional view of the air filter 100 along A-A′ axis is described later in conjunction with FIG. 5, and a second cross-sectional view of the air filter 100 along B-B′ axis is described later in conjunction with FIG. 6.

Although a specific embodiment for an air filter with a detachable pre-filter assembly is described above with respect to FIG. 4, any of a variety of systems and/or processes may be utilized in accordance with embodiments of the disclosure. For example, the perimeter frame 102, with flexibility regarding size and shape, may be configured to either wholly or partially contain the filter element 104 within the cavity. The elements depicted in FIG. 4 may also be interchangeable with other elements of FIGS. 1, 2 and 4-7 as required to realize a particularly desired embodiment.

Referring to FIG. 5, a first cross-sectional view of an air filter with a detachable pre-filter assembly in accordance with various embodiments of the disclosure is shown. In many embodiments, the air filter shown in FIG. 5 may correspond to the air filter 100 shown in FIG. 1. FIG. 5 is described in conjunction with various elements from FIGS. 1, 2, 3, and 4.

In various embodiments, the perimeter frame 102 can assume any size or shape, featuring an array of flanges 302 (e.g., lips or abutments) positioned to accommodate diverse installation methods. As shown, the perimeter frame 102 may be configured to define the cavity 500. Further, the filter element 104 may be disposed within the cavity 500 either partially or wholly. The filter element 104 may extend within the confines of the perimeter frame 102 and may present a textured surface, for example.

In more embodiments, the filter element 104 may seamlessly integrate with the perimeter frame 102 using a snap-fit mechanism. For example, one or more grooves in the filter element 104 may securely connect to the perimeter wall 300 of the perimeter frame 102 for a tight and reliable fit. In yet more embodiments, additional installation configurations such as interface fits, screw fastening, clasp mechanisms, magnetic attachment, elastic tensioning, rotational locking, or the like may be utilized to integrate the filter element 104 with the perimeter frame 102 without limitation.

In additional embodiments, the air filter 100 may include an air intake side 502 and an air exit side 504. Air may flow from the air intake side 502 to the air exit side 504. Airflow path through the air filter 100 is shown by way of arrows 506. In several embodiments, the pre-filter element 108 may be disposed upstream of the filter element 104 in the airflow path through the air filter 100. For example, the pre-filter element 108 may be disposed either at the top or bottom of the filter element 104 such that the pre-filter element 108 is upstream of the filter element 104 in the airflow path. Such placement of the pre-filter element 108 may enhance an efficiency of the air filter 100 as larger particles are captured at the pre-filter element 108 before they reach the filter element 104. In several additional embodiments, the pre-filter assembly 106, including the pre-filter element 108 and the retainer element 110, that is secured to the perimeter frame 102 may face the air intake side 502.

In still more embodiments, the pre-filter assembly 106 may incorporate a snap-fit interface. Further, the pre-filter assembly 106 may be secured to the perimeter frame 102 in the detachable configuration by way of the snap-fit interface. For example, the retainer element 110 may engage with the perimeter frame 102 through corresponding grooves, ensuring a secure and snug fit. In still yet more embodiments, the pre-filter assembly 106 may incorporate one or more interlocking features. Examples of the interlocking features may include male and female interlocks or other complementary design elements that allow two components to fit together securely. Further, the pre-filter assembly 106 may be secured to the perimeter frame 102 in the detachable configuration by way of the one or more interlocking features. In several additional embodiments, the pre-filter assembly 106 may be secured to the perimeter frame 102 by way of magnetic attachment mechanisms, and elastic tensioning mechanism, where the perimeter frame 102 incorporates magnetic elements, elastic elements, or tensioning mechanisms to engage with the retainer element 110.

Although a specific embodiment for an air filter with a detachable pre-filter assembly is described above with respect to FIG. 5, any of a variety of systems and/or processes may be utilized in accordance with embodiments of the disclosure. For example, the pre-filter assembly 106 may be secured to the perimeter frame 102 in the detachable configuration by way of one or more fastening elements, such as screws, clasps, nut bolts, etc. The elements depicted in FIG. 5 may also be interchangeable with other elements of FIGS. 1-4 and 6-7 as required to realize a particularly desired embodiment.

Referring to FIG. 6, a second cross-sectional view of an air filter with a detachable pre-filter assembly in accordance with various embodiments of the disclosure is shown. In many embodiments, the air filter shown in FIG. 6 may correspond to the air filter 100 shown in FIG. 1. FIG. 6 is described in conjunction with various elements from FIGS. 1, 2, 3, 4, and 5.

In many embodiments, the perimeter frame 102 may be comprised of solid materials such as durable plastic or other sturdy substances, without limitation. The perimeter frame 102 may serve as the structural foundation, ensuring the integrity of the air filter 100 during use. The filter element 104, housed within the perimeter frame 102, may constitute the primary or core filtration component in the air filter 100. Further, the pre-filter assembly 106, including the pre-filter element 108 and the retainer element 110, may be secured to the perimeter frame 102 in the detachable configuration. The pre-filter element 108 may be disposed adjacent to the filter element 104, and the retainer element 110 may be disposed adjacent to the pre-filter element 108. The retainer element 110 may be further detachably engaged with the perimeter frame 102. For example, the pre-filter element 108 may be sandwiched between the filter element 104 and the retainer element 110.

In many embodiments, the pre-filter element 108 may mirror a size and shape of the filter element 104, although certain variations may exist where it could be slightly smaller or larger. The combination of a solid perimeter frame 102 and the option for a detachable supplementary pre-filter may enhance the overall effectiveness and versatility of the air filter 100 in various applications. In numerous embodiments, the pre-filter assembly 106 may be configured to support at least one detachment and reattachment iteration without deformation. For example, the perimeter frame 102 and the retainer element 110 exhibit a minimum degree of flexibility, allowing the retainer element 110 to be removed and reinstalled without causing any damage and deformation to the perimeter frame 102 and the retainer element 110. Further, the retainer element 110 is sturdy enough to flex during the removal and reinstallation without breaking.

Although a specific embodiment for an air filter with a detachable pre-filter assembly is described above with respect to FIG. 6, any of a variety of systems and/or processes may be utilized in accordance with embodiments of the disclosure. For example, the pre-filter element 108 can be additionally or alternatively disposed downstream of the filter element 104 in an airflow path through the air filter 100. The elements depicted in FIG. 6 may also be interchangeable with other elements of FIGS. 1-5 and 7 as required to realize a particularly desired embodiment.

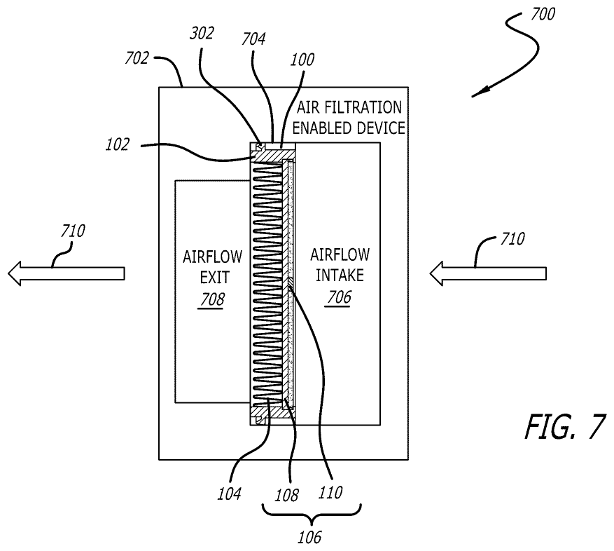

Referring to FIG. 7, a block diagram of an air-filtration enabled device 700 featuring an air filter with a detachable pre-filter assembly in accordance with various embodiments of the disclosure is shown. Examples of the air-filtration enabled device 700 may include a vacuum cleaner, an HVAC system, an air purifier, or the like, which help maintain air quality. In further embodiments, the air-filtration enabled device 700 can be a device deployed in an automotive cabin, an industrial setting, a medical environment, or the like to enhance air purity and safeguard health. In many embodiments, the air filter shown in FIG. 7 may correspond to the air filter 100 shown in FIG. 1. FIG. 7 is described in conjunction with various elements from FIGS. 1-6.

In various embodiments, the air-filtration enabled device 700 may include a housing 702. The housing 702 may house the air filter 100, a mounting interface 704, an air intake side 706, and an air exit side 708. Air may flow from the air intake side 706 to the air exit side 708, where airflow path is indicated by arrows 710. The air filter 100 may be coupled to the mounting interface 704 to maintain the structural integrity of the air filter 100 during the operation of the air-filtration enabled device 700. In an example, the air filter 100 may be secured or coupled to the mounting interface 704 by way of the flange 302 provided on the perimeter frame 102 of the air filter 100. The mounting interface 704 may vary based on the type of the air-filtration enabled device 700. For example, in a scenario where the air-filtration enabled device 700 is an HVAC unit, the flange 302 may be coupled to a ductwork or a filter housing mechanism in the HVAC unit.

Although a specific embodiment for an air-filtration enabled device featuring an air filter with a detachable pre-filter assembly is described above with respect to FIG. 7, any of a variety of systems and/or processes may be utilized in accordance with embodiments of the disclosure. For example, the detachable pre-filter assembly 106 can be integrated into any fluid filter and not limited to air filters. The elements depicted in FIG. 7 may also be interchangeable with other elements of FIGS. 1-6 as required to realize a particularly desired embodiment.

Although the present disclosure has been described in certain specific aspects, many additional modifications and variations would be apparent to those skilled in the art. Any of the various processes described above can be performed in alternative sequences and/or in parallel to achieve similar results in a manner that is more appropriate to the requirements of a specific application. It is therefore to be understood that the present disclosure can be practiced other than specifically described without departing from the scope of the present disclosure. Thus, embodiments of the present disclosure should be considered in all respects as illustrative and not restrictive. It will be evident to the person skilled in the art to freely combine several or all the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each, and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. An air filter, comprising:
a perimeter frame that defines a cavity;
a filter element disposed within the cavity; and
a pre-filter assembly secured to the perimeter frame in a detachable configuration, wherein the pre-filter assembly comprises:
a pre-filter element disposed adjacent to the filter element; and
a retainer element disposed adjacent to the pre-filter element, wherein the retainer element retains the pre-filter element adjacent to the filter element and engages with the perimeter frame.

2. The air filter of claim 1, wherein the pre-filter element is disposed upstream of the filter element in an airflow path through the air filter.

3. The air filter of claim 2, wherein the pre-filter element is disposed below the filter element.

4. The air filter of claim 2, wherein the pre-filter element is disposed above the filter element.

5. The air filter of claim 1, wherein the pre-filter element exhibits a porous structure.

6. The air filter of claim 1, wherein the pre-filter element exhibits a single-layer structure.

7. The air filter of claim 1, wherein the pre-filter element exhibits a multi-layer structure.

8. The air filter of claim 1, wherein the pre-filter element is washable and reusable.

9. The air filter of claim 1, wherein the retainer element is configured to support the pre-filter element to preserve a shape of the pre-filter element.

10. The air filter of claim 1, wherein the retainer element comprises:
a support frame; and
one or more bracing members included within a space defined by the support frame, wherein the one or more bracing members are coupled to the support frame.

11. The air filter of claim 10, wherein the one or more bracing members are in an X-brace configuration.

12. The air filter of claim 1, wherein the pre-filter assembly is configured to support at least one detachment and reattachment iteration.

13. The air filter of claim 1, wherein the pre-filter assembly is configured to support at least one detachment and reattachment iteration without deformation.

14. The air filter of claim 1, wherein the pre-filter assembly incorporates a snap-fit interface, and wherein the pre-filter assembly is secured to the perimeter frame in the detachable configuration by way of the snap-fit interface.

15. The air filter of claim 1, wherein the pre-filter assembly incorporates one or more interlocking features, and wherein the pre-filter assembly is secured to the perimeter frame in the detachable configuration by way of the one or more interlocking features.

16. The air filter of claim 1, wherein the pre-filter assembly is secured to the perimeter frame in the detachable configuration by way of one or more fastening elements.

17. The air filter of claim 1, wherein the perimeter frame comprises:
a perimeter wall that encompasses the cavity; and
a flange along the perimeter wall, wherein the flange is configured to interface with a mounting surface to mount the air filter.

18. A pre-filter assembly for an air filter, wherein the air filter comprises a perimeter frame and a filter element in the perimeter frame, the pre-filter assembly comprising:
a pre-filter element disposed adjacent to the filter element; and
a retainer element disposed adjacent to the pre-filter element wherein
the retainer element retains the pre-filter element adjacent to the filter element and engages with the perimeter frame, and
the pre-filter assembly is secured to the perimeter frame in a detachable configuration.

19. The pre-filter assembly of claim 18, wherein the pre-filter assembly is configured to support at least one detachment and reattachment iteration.

20. An air-filtration enabled device, comprising:
a mounting interface; and
an air filter coupled to the mounting interface, wherein the air filter comprises:
a perimeter frame that defines a cavity;
a filter element disposed within the cavity; and
a pre-filter assembly secured to the perimeter frame in a detachable configuration, wherein the pre-filter assembly comprises:
a pre-filter element disposed adjacent to the filter element; and
a retainer element disposed adjacent to the pre-filter element, wherein the retainer element retains the pre-filter element adjacent to the filter element and engages with the perimeter frame.
